(19) United States
(12) Patent Application Publication
(10) Pub. No.: US 2001/0028216 A1
(43) Pub. Date: Oct. 11, 2001

(54) Display device

(76) Inventors: Akira Tokai, Kawasaki (JP); Manabu Ishimoto, Kawasaki (JP); Tutae Shinoda, Kawasaki (JP); Keiichi Betsui, Kawasaki (JP)

Correspondence Address: STAAS & HALSEY, 700 Eleventh Street, N.W., Suite 500, Washington, DC, 20001, US

(21) Appl. No.: 09/729,322

(22) Filed: Dec. 5, 2000

(30) Foreign Application Priority Data
Mar. 17, 2000 (JP) 2000-75381

(51) Int. Cl. H01J 1/62

(52) U.S. Cl. 313/496

(57) ABSTRACT

A display device is realized that has a group of elongated illuminators that enable the electrode matrix to be formed easily. The display device has a screen made of a substrate and a group of elongated illuminators that are arranged on the substrate. Elongated electrode supporters are arranged on at least one side of the illuminator in the width direction. The elongated electrode supporter has plural electrodes that are arranged along the longitudinal direction of the illuminator. A wiring conductive pattern is formed on the substrate for supplying electricity to the plural electrodes of the electrode supporter. A partial light emission of the illuminator is controlled by the wiring conductive pattern and the plural electrodes.

### BACKGROUND OF THE INVENTION 1. Field of the Invention

The present invention relates to a display device comprising plural elongated illuminators.

There is a limit to enlarging a screen of a display having a single structure. A very large display of self-luminous type that is used in a stadium or an event place is made of plural light sources such as cathode-ray tubes or light emitting diodes (LEDs) arranged in a matrix. Normally, the total number of the light sources is several hundreds of thousands or more, and a lot of labors and costs are required for assembling the display. Therefore, it is asked to realize a bright screen having a dimension of several meters easily. 2. Description of the prior art

A very large display utilizing a light emission principle of a plasma display panel (PDP) has been suggested by the present applicant as a “large gas discharge display panel,” which is disclosed in Japanese unexamined patent publication No. 61-103187.

The suggested display has a combination structure of plural elongated illuminators arranged in one direction. Each of the illuminators corresponds to a PDP having a single row or column. This display has following advantages over other kinds of displays.

(1) The illuminators are arranged in one direction, so the number of man-hours for assembling them can be smaller than the case where they are arranged in two directions (row and column directions).

(2) The cells of a row are formed as a unit, so a lighter and less expensive display can be realized than the case where an independent light source is arranged for each cell.

(3) The illuminator has a higher luminance than a light emitting diode.

In addition, though the dimension (the numbers of rows and columns) of a PDP having a structure is determined by the size of a glass substrate, the suggested display having the combination structure can realize any rows (or columns) of display by increasing or decreasing the number of arranged illuminators. Though the number of rows (or columns) depends on a length of a light emission module, it is much easier elongating the illuminator than enlarging a PDP. It is not realistic to manufacture a glass substrate having a very large area from the viewpoint of a plant and a conveyance. Namely, when trying to manufacture a large display by a single structure, a glass plate that is larger than a screen size should be handled, and a size larger than 100 inches is not realistic. The upper limit of the dimension of a display (such as a pixel size or a screen size) that can be produced depends on manufacturing facilities. In order to produce a large display having a larger dimension than the manufacturing facilities, new manufacturing facilities have to be constructed. In contrast, if the production is performed by a unit of line (row), an engineering change for easy assembling and for responding to the dimension of the display can be performed without a large change of the manufacturing facilities. Therefore, various sizes of displays can be realized at a low cost.

Other conventional examples of such arrangement of elongated illuminators are explained in Japanese unexamined patent publications No. 11-3649 and No. 11-162358. The former discloses a display device having a structure in which fibers with embedded electrodes are arranged on the front side of the illuminators arranged in the horizontal direction. The latter discloses a display device in which illuminating tubes are arranged on a substrate with column electrodes and row electrodes are formed on the front side of the illuminating tubes.

In the conventional above-mentioned display device disclosed in Japanese unexamined patent publication No. 61-103187, electrodes of many illuminators should be connected so as to form an electrode matrix after arranging the illuminators, and the wire connection is a burdensome job. In the conventional display device disclosed in Japanese unexamined patent publications No. 11-3649 or No. 11-162358, the electrodes extending in one direction of the electrode matrix are arranged in the front side of the illuminator, so a consideration of decreasing a light shield by using a transparent material is required. In addition, when forming a row electrode over the illuminators after arranging them, it is difficult to secure an accuracy of the position of a paste print for a large screen if a thick-film process is used. In contrast, if a thin-film process is used, a unit of production becomes not a line but a surface, so the above-mentioned advantage of the production facilities fades out.

### SUMMARY OF THE INVENTION

The object of the present invention is to provide a display device made of a group of elongated illuminators, which enable an electrode matrix to be formed easily.

FIGS. 1A-1C are diagrams showing a basic concept of the present invention.

The display device 10 of the present invention has illuminators 40 arranged on a substrate 20, and electrode supporters 50 are arranged along each of the illuminators 40. In order to let plural portions (cells) of the illuminator 40 in the longitudinal direction emit light selectively in any desired combination, the electrode supporter 50 is provided with electrodes X, Y. The substrate 20 is provided with wiring conductive patterns 30x, 30y for supplying electricity to the electrodes X, Y. The electrodes X, Y and the wiring conductive patterns 30x, 30y are connected electrically by assembling the substrate 20 and the electrode supporter 50, so that an electrode matrix is formed that enables any image display.

### BRIEF DESCRIPTION OF THE DRAWINGS

FIGS. 1A-1C are diagrams showing a basic concept of the present invention.

FIG. 2 is a diagram showing a basic form of assembling a display device according to the present invention.

FIGS. 3A and 3B are diagrams showing another example of the electrode supporter.

FIGS. 4A and 4B are schematic structural diagrams of a display device according to a first embodiment of the present invention.

FIGS. 5A-5C are diagrams showing a substrate structure of the display device according to the first embodiment.

FIGS. 6A and 6B are diagrams showing an example of the illuminator.

FIG. 7 is a plan view of an integrated display device using the display devices according to the first embodiment.

FIGS. 8A and 8B show a linking structure of the display devices according to the first embodiment.

FIGS. 9A-9D are diagrams showing another example of the illuminator.

FIGS. 10A and 10B are diagrams showing a structure of the illuminator and the electrode supporter according to a second embodiment.

FIGS. 11A-11C are diagrams showing the substrate arrangement of the integrated display device according to the second embodiment.

FIGS. 12A and 12B are diagrams showing a variation of the electrode supporter and the substrate according to the second embodiment.

FIG. 13 is a diagram showing a variation of the outer shape of the illuminator.

FIGS. 14A and 14B are diagrams showing another embodiment of assembling the display device.

FIGS. 15A and 15B are diagrams showing a structure of the illuminator and the electrode supporter according to the third embodiment.

### DESCRIPTION OF THE PREFERRED EMBODIMENTS

Hereinafter, the present invention will be explained more in detail with reference to embodiments and drawings.

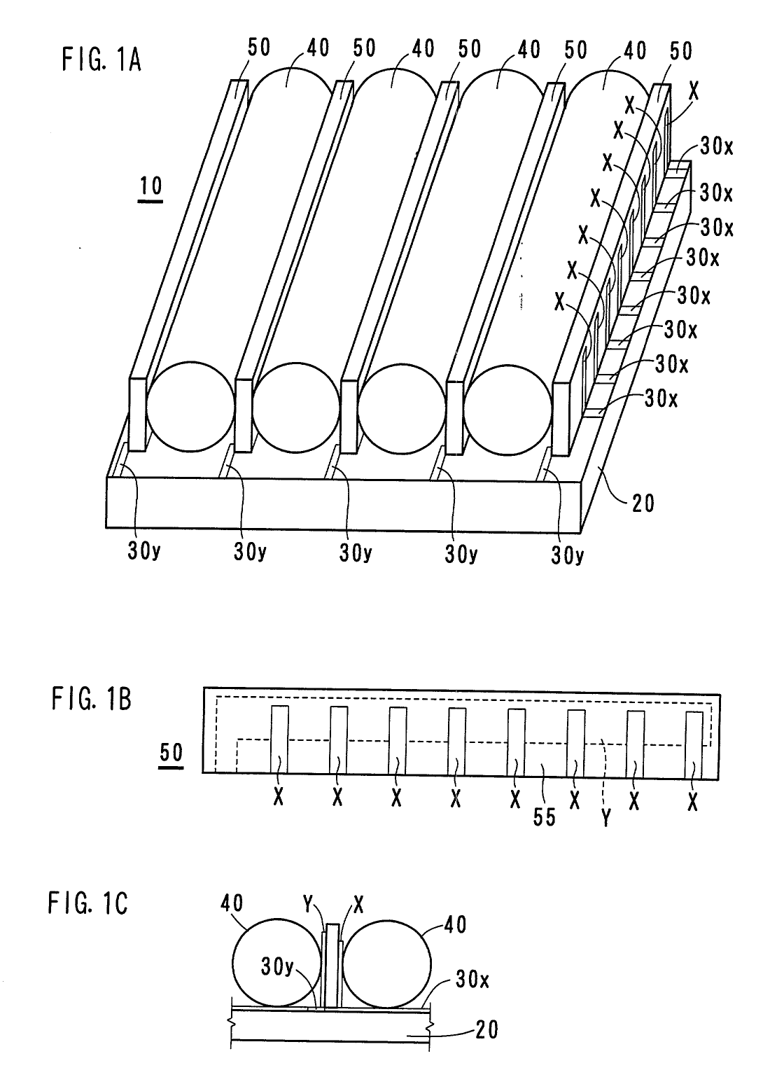

FIGS. 1A-1C are diagrams showing a basic concept of the present invention.

The display device 10 of the present invention has illuminators 40 arranged on a substrate 20, and electrode supporters 50 are arranged along each of the illuminators 40. In order to let plural portions (cells) of the illuminator 40 in the longitudinal direction emit light selectively in any desired combination, the electrode supporter 50 is provided with electrodes X, Y. The substrate 20 is provided with wiring conductive patterns 30x, 30y for supplying electricity to the electrodes X, Y. The electrodes X, Y and the wiring conductive patterns 30x, 30y are connected electrically by assembling the substrate 20 and the electrode supporter 50, so that an electrode matrix is formed that enables any image display.

A preferred embodiment of the electrode supporter 50 is a double-sided wiring board. Anodes are arranged on one side of an elongated plate support member 55, and cathodes are arranged on the other side. However, these anode and cathode do not make an electrode pair that is used for controlling one illuminator 4 and are related to two illuminators 40 that are adjacent to each other. Namely, two electrode supporters 50 facing to each other with respect to the illuminator 40 are necessary for controlling the illuminator 40. It is possible to arrange either the anode or the cathode on one electrode supporter 50, but in this case two kinds of electrode supporters 50 have to be prepared for forming the electrode matrix. If a single-sided wiring board is used, the number of electrode supporters 50 becomes twice the number in the case of the double-sided wiring board. In FIG. 1B, the electrodes X for a predetermined number of cells are arranged on one side of the support member 55, and the electrode Y extending in the longitudinal direction are formed on the other side. One of the electrodes X, Y is used as the anode, and the other is used as the cathode. Each of the electrodes X extends from the position abutting the illuminator 40 to the lower end of the support member 55, so as to connect with the wiring conductive pattern 30x (see FIG. 1C). The electrode Y has a lead-out portion at an end in the longitudinal direction for connecting with the wiring conductive pattern 30y.

If the material of the support member 55 is an elastomer (e.g., a polyurethane resin), the electrodes X, Y and the illuminator 40 can be contacted more tightly, so that the light emission control can be performed in more stable manner. In addition, the illuminator 40 can be held more securely. The effect of the tight contact between the electrodes X, Y and the illuminator 40 can be obtained if at least the part of the support member 55 around the contact portion with the illuminator 40 is elastic.

In the illustrated example, the length of the electrode supporter 50 corresponds to one illuminator 40. In other example in which two or more illuminators 40 are joined so as to form a light emission line, the electrode supporter 50 can have a length that corresponds to the light emission line. On the contrary, two or more electrode supporters 50 can join along one illuminator 40. Concerning the substrate 20 too, plural sub substrates can be joined so as to make one substrate 20.

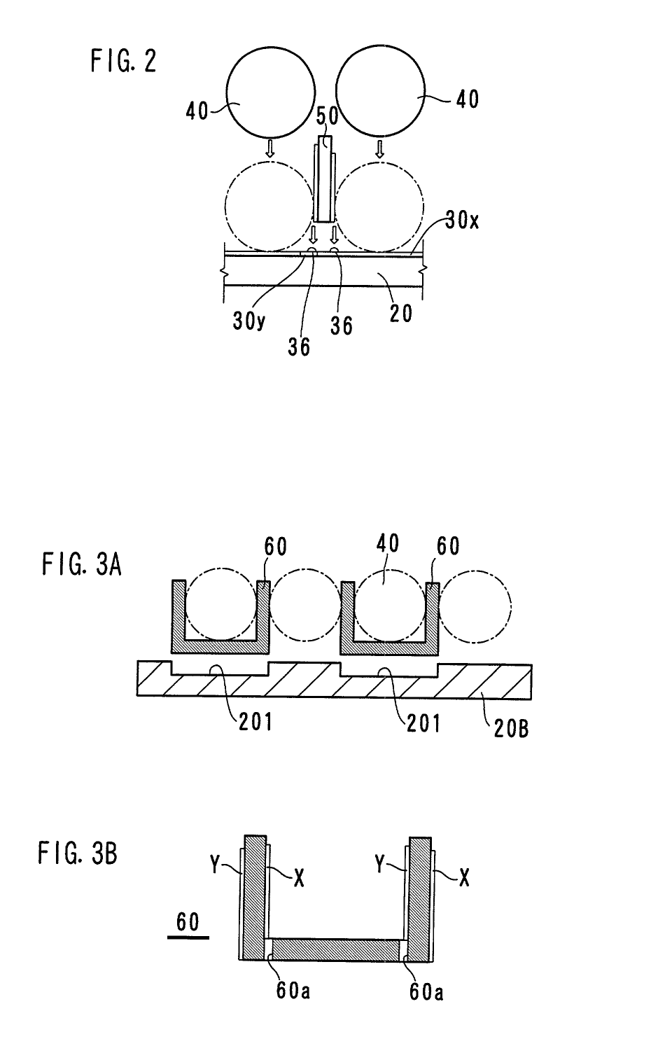

FIG. 2 is a diagram showing a basic form of assembling a display device according to the present invention.

Bumps 36 are formed on predetermined positions on the wiring conductive patterns 30x, 30y. The bumps 36 and the electrodes X, Y are aligned so that the electrode supporter 50 is fixed to the substrate 20. In other method using the conventional mounting technology, the substrate 20 is provided with a groove, in which the electrode supporter 50 is inserted and fixed.

FIGS. 3A and 3B are diagrams showing another example of the electrode supporter.

The electrode supporter 60 in this example has an elongated body with a substantially C-shaped cross section in which a bottom portion and a pair of side portions are integrated. The side portion corresponds to the above-mentioned electrode supporter 50, and a gap between the side portions is adapted to the width of the illuminator 40. The electrode supporters 60 are attached to the substrate 20B at the rate of two electrode supporters 60 per three light emission lines. In the assembled state, the neighboring electrode supporters 60 sandwich the illuminator 40 for one light emission line. In order to equalize heights of the illuminator 40 between the pair of electrode supporters 60 and the illuminator 40 inside each electrode supporter 60, the substrate 20B is provided with a groove 201 in which the bottom portion of the electrode supporter 60 fits. Actually, a wiring conductive pattern crosses the groove 201 though it is not illustrated. This groove 201 is useful also for the registration of the electrode supporter 60 and the illuminator 40.

The bottom portion of the electrode supporter 60 has a through hole 60a for leading out the electrodes X, Y that are provided at the inner surface of the side portion to the lower surface. A plating technology can be used for forming a conductor in the through hole 60a.

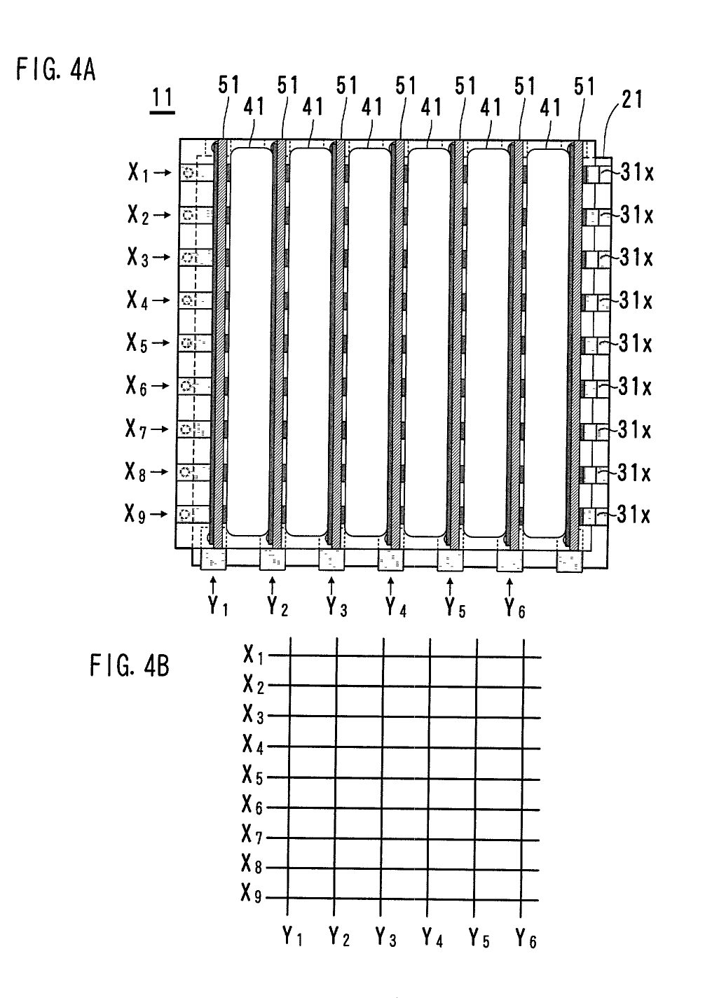

FIGS. 4A and 4B are schematic structural diagrams of a display device according to a first embodiment of the present invention. FIG. 4A shows an appearance viewed from the top. FIG. 4B shows an electrode matrix.

The display device 11 has a screen including a substrate 21 and a group of elongated illuminators 41 arranged on the substrate 21. Electrode supporters 51 having elongated plate-like shapes are arranged on both sides of each illuminator 41 in the width direction. On one side of the electrode supporter 51, electrodes X (the suffix indicates the order of the arrangement in the figure) having a strap shape are arranged along the longitudinal direction of the illuminator 41. On the other side, electrodes Y are arranged that extend along the longitudinal direction of the illuminator 41. The electrode X is connected electrically with wiring conductive patterns 31x formed on the substrate 21, so that the electrode matrix is formed.

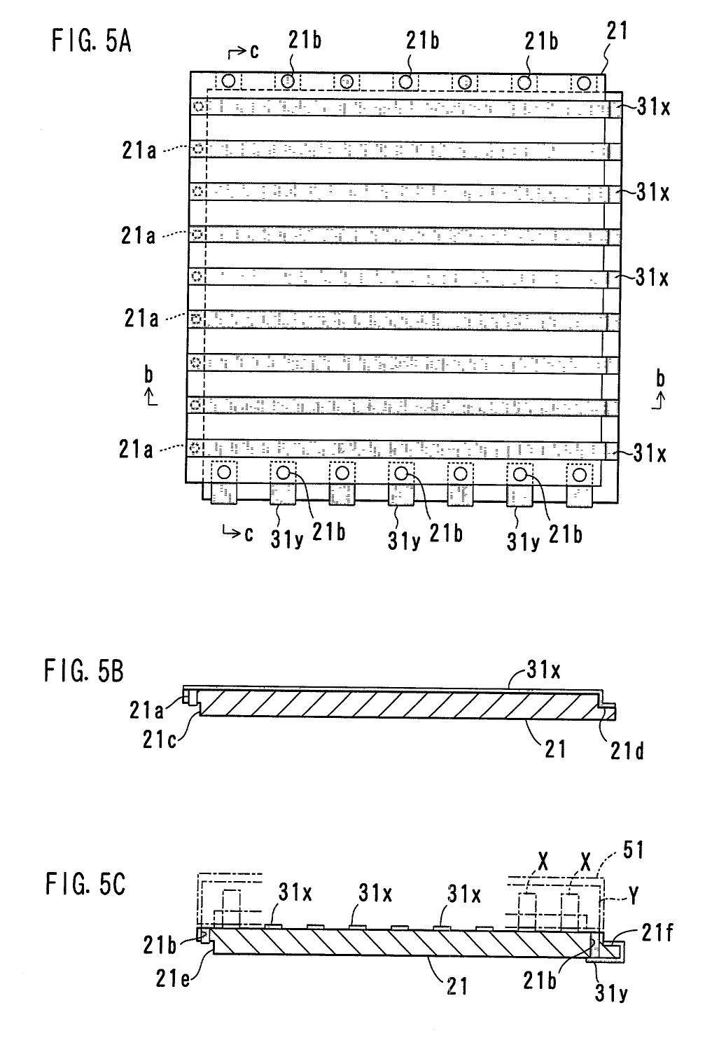

FIGS. 5A-5C are diagrams showing a substrate structure of the display device according to the first embodiment. FIG. 5A is a plan view. FIG. 5B is a cross section cut along the b-b line of FIG. 5A. FIG. 5C is a cross section cut along the c-c line of FIG. 5A.

The wiring conductive patterns 31x are formed on the front side of the substrate 21, and wiring conductive patterns 31y are formed on the rear side. The wiring conductive patterns 31y become terminal for connecting the electrodes Y to a drive circuit. As shown in Fig. 5B, on both sides of the arrangement direction of the illuminator on the substrate 21, step portions 21c, 21d are formed for linking the plural substrates 21. On the step portion 21c whose backside is a recess, a through hole 21a is formed for leading out the wiring conductive pattern 31x on the front side to the rear side. In addition, a through hole 21b is formed at the position corresponding to the wiring conductive pattern 31y. As shown in FIG. 5C, the electrode Y and the wiring conductive pattern 31y are connected via through hole 21b. In addition, step portions 21e and 21f are formed on both sides of the longitudinal direction of the illuminator in the substrate 21 for linking the plural substrates 21.

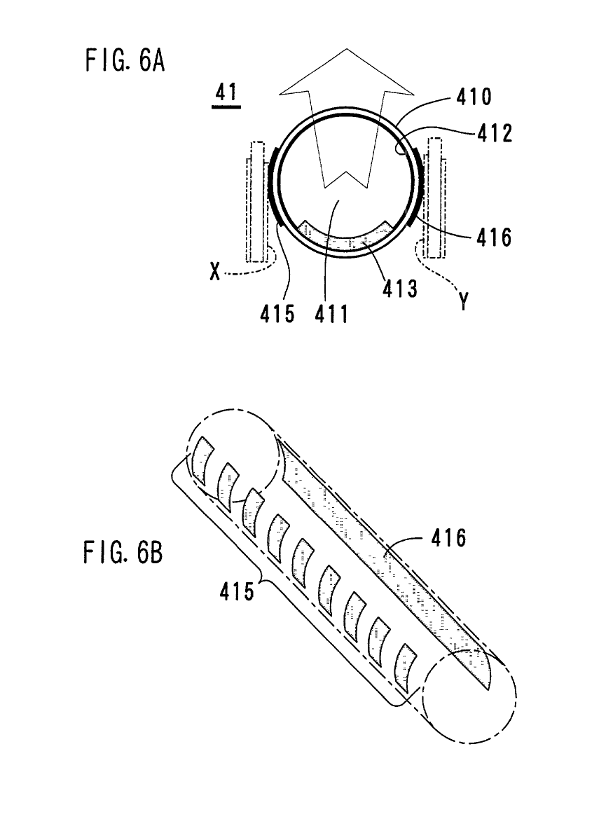

FIGS. 6A and 6B are diagrams showing an example of the illuminator. FIG. 6A shows a structure of the cross section along the width direction. FIG. 6B shows a location of an auxiliary conductor.

The illustrated illuminator 41 emits light by a gas discharge in the same manner as a PDP. The inner surface of the glass tube 410 sealing a discharge gas space 411 is covered with a protection film 412 made of magnesia, and a fluorescent material layer 413 is formed at the rear side in the tube. In order to form the protection film 412, a liquid magnesium organic salt is coated and the pyrolysis of the magnesium organic salt is generated. According to this method, a uniform film can be formed on the inner surface of the glass tube having the diameter of 1 mm and the thickness of 100 μ m. On the outer surface of the glass tube 410, auxiliary conductors 415, 416 are fixed for enlarging the effective electrode area and for defining the cell position. The auxiliary conductors 415 are formed in a land pattern, and the number thereof is the same as the number of the electrodes X. The auxiliary conductors 415 are arranged so that each of them abuts each of the electrodes X. The auxiliary conductor 416 is formed in a stripe pattern and abuts the electrode Y over the entire length. There are some methods of forming the auxiliary conductors 415, 416. One method is printing a conductive paste in a predetermined pattern. In another method, a conductive film is formed on the entire surface of the outside and is patterned by a photolithography. In still another method, a photosensitive conductive paste is coated on the area including the forming area and is patterned by a photolithography.

In the display device 11 that utilizes such illuminators 41, a drive method for a so-called simple matrix structure PDP can be used for displaying an image. Tree kinds of illuminators 41 having light emission colors of red, green and blue are arranged in a predetermined order, so that a color display can be realized.

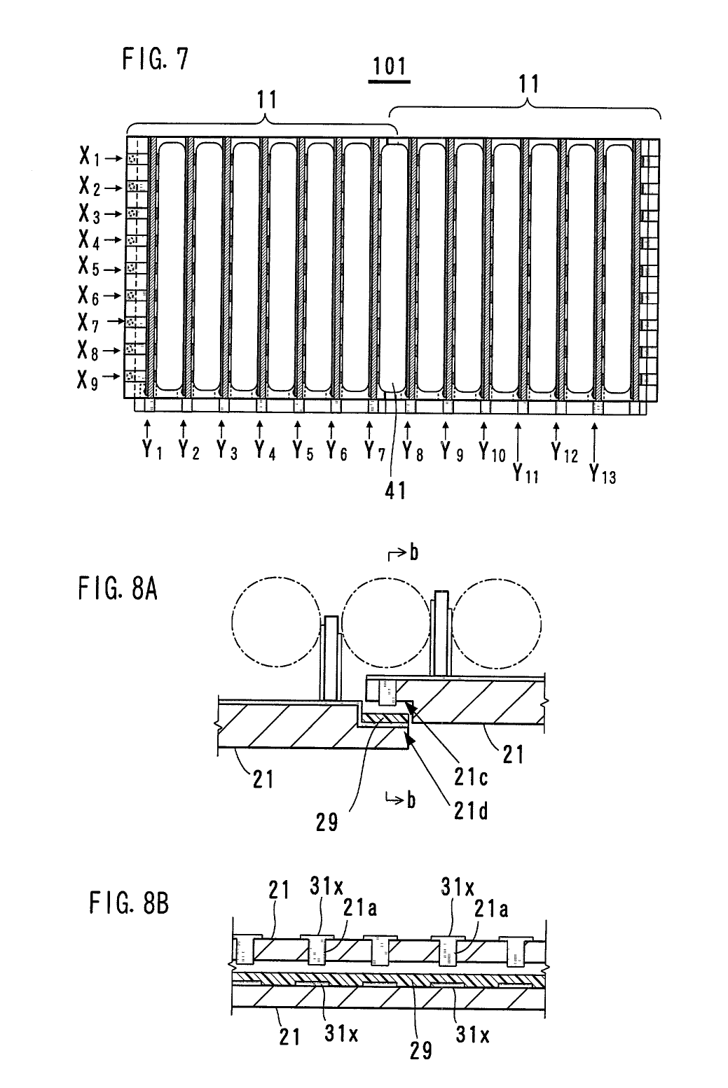

FIG. 7 is a plan view of an integrated display device using the display devices according to the first embodiment. The integrated display device 101 includes two display devices 11. The illuminator 41 is disposed also at the junction of the display devices 11, so the number of the illuminators 41 is larger than twice the number of illuminators used in a single display device 11.

FIGS. 8A and 8B show a linking structure of the display devices according to the first embodiment. FIG. 8A is a cross section, and FIG. 8B is a cross section of FIG. 8A cut along b-b line.

When assembling the integrated display device 101, the step portion 21c of the substrate 21 and the step portion 21d of the other substrate 21 are overlaid. An anisotropic conductive adhesive 29 is used for electrically connecting the two substrates 21, and the substrates are combined by thermocompression bonding.

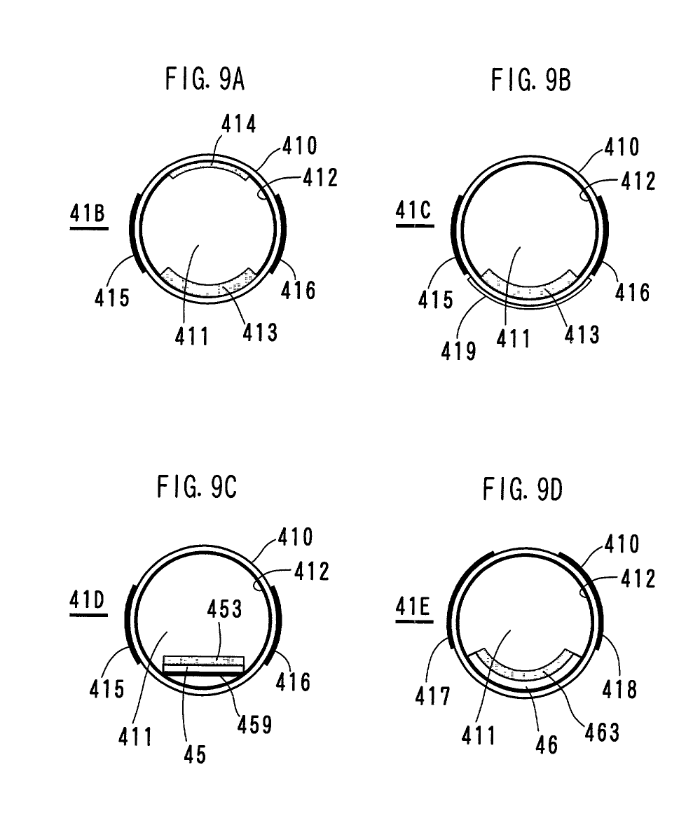

FIGS. 9A-9D are diagrams showing another example of the illuminator. In FIGS. 9A-9D, the elements corresponding to those in FIG. 6 are denoted by the same reference as in FIG. 6, so that the explanations of the elements are omitted.

In the illuminator 41B show in FIG. 9A, a fluorescent material 414 that is thinner than the fluorescent material layer 413 is disposed at the front side and inside the glass tube 410. The light emission color of the fluorescent material 414 is the same as that of the fluorescent material layer 413. Since the fluorescent material 414 is thin, the visible light that was generated in the fluorescent material layer 413 passes the fluorescent material 414 with being hardly attenuated. The light emission of the fluorescent material 414 enhances the luminance. In the illuminator 41C shown in FIG. 9B, a reflection film 419 is provided at the rear portion of the fluorescent material layer 413 in the outer surface of the glass tube 410 light emission so as to enhance the efficiency. The material of the reflection film 419 can be a metal film such as an aluminum film or a low melting point glass that is colored white. The reflection film can be provided to the substrate 21. In the illuminator 41D shown in FIG. 9D, the fluorescent material layer 453 is formed on the support member 45 that is separated from the glass tube 410. The fluorescent material layer 453 is disposed in the gas space 411 by inserting the support member 45 into the glass tube 410. The support member 45 is an elongated plate having the thickness of approximately 50 μ m, and the backside thereof is provided with a reflection film 459. The reflection film 459 can be provided at the front side of the support member 45, and the fluorescent material layer 453 can be formed on the reflection film 459. The fluorescent material layer 453 is formed by a screen printing method or an application method using a dispenser. In the structure using the separate support member 45, the fluorescent material layer 453 can be formed easily so as to exist in a part of the inner surface.

In the illuminator 41E shown in FIG. 9D, the fluorescent material layer 463 is formed on the plate support member 46 that is curved along the inner surface of the glass tube 410. The fluorescent material layer 463 is disposed in the gas space 411 by inserting the support member 46 into the glass tube 410. The support member 46 is made by cutting a glass tube having the outer diameter of 0.8 mm in the longitudinal direction, for example. In order to reduce a deterioration of the fluorescent material due to the discharge, the auxiliary conductors 417 and 418 are disposed at the front side being opposite to the fluorescent material layer 463 and are made of transparent conductive material so as to avoid a light shield.

In another structure, a fluorescent material layer that covers the entire inner surface of the glass tube 410 can be provided. The front side portion of the fluorescent material layer is preferably thinner than the backside portion so that the light emission efficiency is enhanced. The fluorescent material layer having parts of different thickness can be formed by the following process. A fluorescent material paste is injected inside the glass tube 410 after the protection film 412 is formed. Then the glass tube 410 is laid in the horizontal position while the fluorescent material paste is dried. Since the fluorescent material particles are settled by their weight during the drying process, the fluorescent material is formed in such a way that the lower portion is thick and the upper portion is thin at the inner wall of the tube. In another method, a photosensitive paste is used, and the exposing light quantity is adjusted so that the film thickness can be altered. By these methods, the thickness of the fluorescent material layer can be not uniform, and the auxiliary conductors 415, 416 are formed so that the thin portion is the front side.

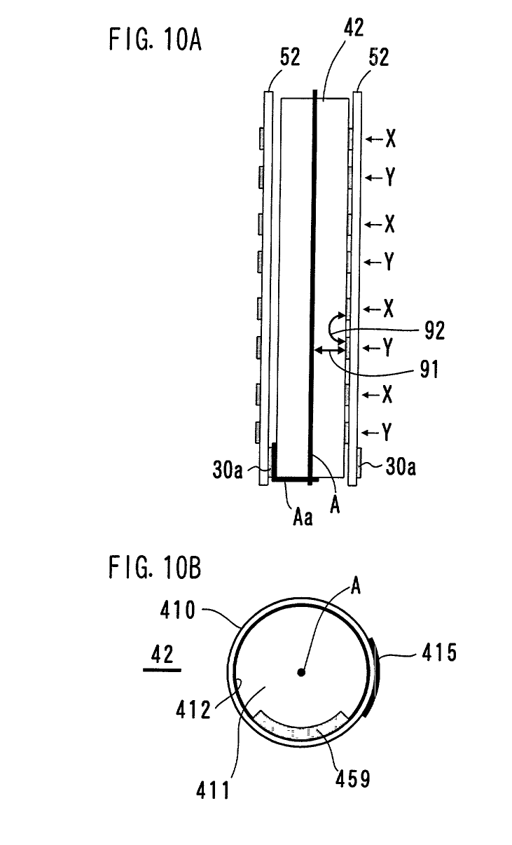

FIGS. 10A and 10B are diagrams showing a structure of the illuminator and the electrode supporter according to a second embodiment.

The illuminator 42 has an address electrode A that is a metal wire (made of copper or aluminum, for example) or a metal wire covered with an insulation coat along the axis of the glass tube 410. A conductor pattern Aa is provided at one end of the glass tube 410 for leading out the address electrode A to the outer surface of the glass tube 410, and a conductor pattern 30a contacting this conductor pattern Aa is provided to one side of the electrode supporter 52. Plural electrode pairs including the electrode X and the electrode Y are arranged on the other side of the electrode supporter 52. An auxiliary conductor 415 is disposed at the outer surface of the illuminator 42 so as to contact with an electrode X and an electrode Y. In the illuminator 42, a discharge 91 is generated between the address electrode A and the electrode Y for selecting a cell, and a discharge 92 is generated between the electrode X and the electrode Y so that the fluorescent material layer 459 emits light in the same way as the three-electrode surface discharge type PDP.

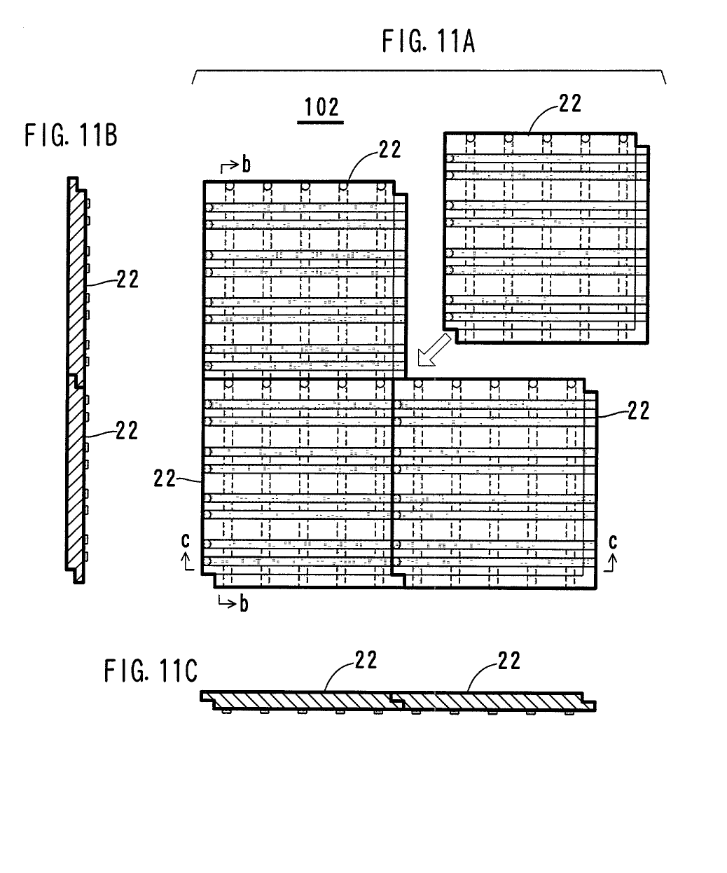

FIGS. 11A-11C are diagrams showing the substrate arrangement of the integrated display device according to the second embodiment.

The integrated display device 102 includes plural substrates 22 being linked in the horizontal direction and the vertical direction. Wiring conductive patterns that are connected with the electrodes X, Y are formed on one side of each substrate 22. On the other side, wiring conductive patterns for connecting the address electrode A between the substrates and a through hole for connecting them with the conductor pattern 30a of the electrode supporter 52 are formed. In addition, a step portion for a junction is provided to all sides of the substrate 22. The structure of the junction is the same as in FIG. 8.

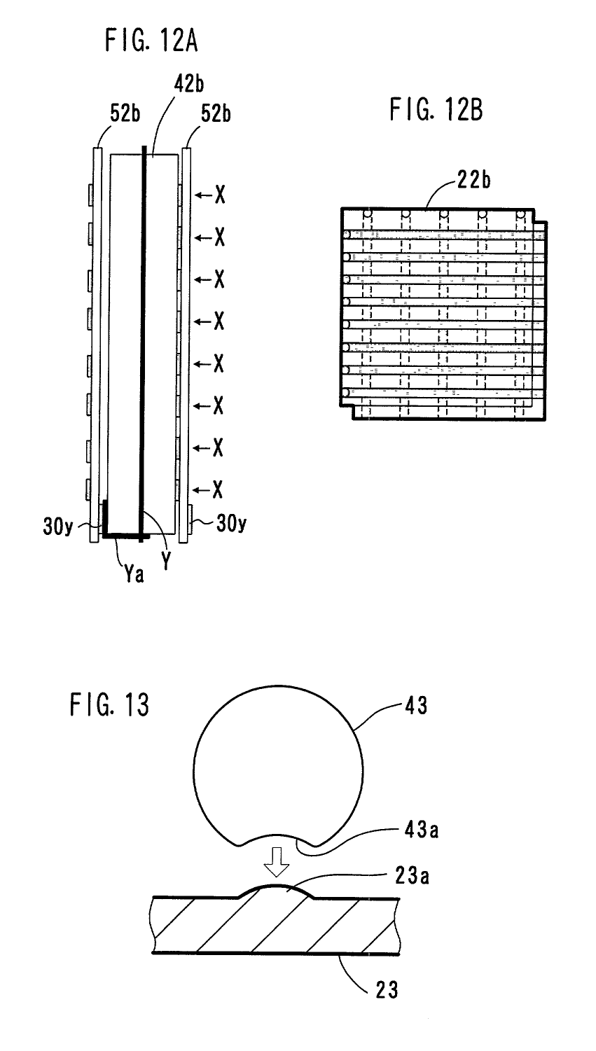

FIGS. 12A and 12B are diagrams showing a variation of the electrode supporter and the substrate according to the second embodiment. The structure of the illuminator 42b is the same as the illuminator 42 shown in FIG. 10. However, the metal wire braced inside is used as the electrode Y for the display discharge. The electrode Y is electrically connected to the conductor pattern 30y that is formed on one side of the electrode supporter 52b via the conductor pattern Ya that is formed on the outer surface of the glass tube. On the other surface of the electrode supporter 52b, plural electrodes X are arranged at the constant gap. In the illuminator 42b, the cell selection is formed in the simple matrix format. Conductor patterns are arranged on the substrate 22b that supports the plural illuminator 42b at a constant pitch corresponding to the arrangement of the electrodes X.

FIG. 13 is a diagram showing a variation of the outer shape of the illuminator.

The illuminator 43 has a concave portion 43a at the rear side, and the substrate 23 has a convex portion 23a corresponding to the concave portion 43a. The engagement of the concave portion 43a with the convex portion 23a makes the registration of the illuminator 43 easy, and the illuminator 43 can be retained securely.

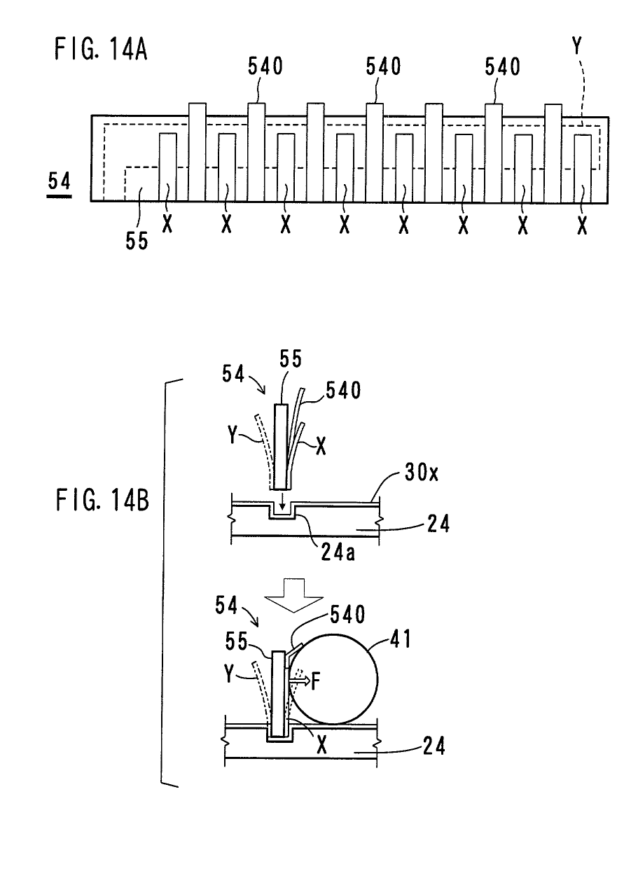

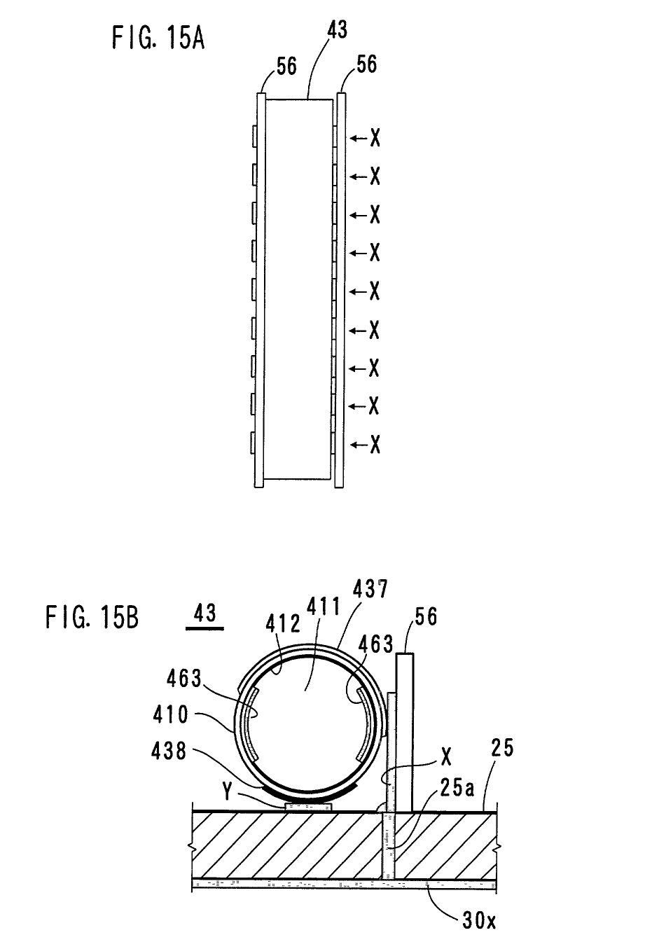

FIGS. 14A and 14B are diagrams showing another embodiment of assembling the display device.

The substrate 24 is provided with a groove 24a in which the siding portion of the electrode supporter 54 fits for fixing the electrode supporter 54. Plural strap electrodes X are provided to one side of the electrode supporter 54, and elongated electrodes Y are provided to the other side. Each electrode X has the lower end that is fixed to the support member 55 and the upper end bending away the support member 55. The electrode supporter 54 fits in the groove 24a of the substrate 24 for fixing and the illuminator 41 is arranged on the substrate 24, when the electrode X is pushed toward the support member 55. Thus, the electrode X generates a force F that tries to push back the illuminator 41. As explained with reference to FIGS. 1A-1C, in the state where the illuminator 41 is sandwiched between a pair of electrode supporters 54, the force F works to fix the illuminator 41. As shown in FIG. 14A, a metal piece 540 that is longer than the electrode X is disposed between the electrodes X, so that the illuminator 41 can be pressed by bending the upper end of the metal piece 540 after arranging the illuminator 41 on the substrate 24. The metal piece 540 can be bent appropriately in advance. It is not necessary to supply electricity to the metal piece 540. The electrode Y can be also used as a pressing member in the same way as the electrode X.

FIGS. 15A and 15B are diagrams showing a structure of the illuminator and the electrode supporter according to the third embodiment.

Plural electrodes X are arranged in a constant pitch on one side of the electrode supporter 56, and the other side is not provided with any electrode. The electrode Y that makes a pair with the electrode X is formed on the substrate 25. As shown in FIG. 15B, a conductor pattern 30x is formed on the back side of the substrate 25, and the electrode X is connected to the conductor pattern 30x via the through hole 25a. In this structure, the request of the insulation property of the electrode supporter 56 is not so strict as the structure in which the electrodes are formed on both sides.

In the illuminator 43, the auxiliary conductor 437 that contacts the electrode X is a transparent conductive film covering the outer surface of the glass tube 410 from the side portion to the upper portion, and the auxiliary conductor 438 contacting the electrode Y is a metal film having a high reflectivity. A fluorescent material layer 463 is formed on the support member that is curved along the inner surface of the glass tube 410. The fluorescent material layer 463 is disposed at the left and the right sides in the gas space 411 by inserting a pair of fluorescent material support members into the glass tube 410.

In the above-mentioned embodiment, the substrates 21-25 can have a curved surface. In addition, the substrates 21-25 can be arranged along the curved surface, so that the curved screen can be assembled. The arrangement direction of the illuminators is not limited to the horizontal direction. The illuminator can be arranged in the vertical direction. However, it is advantageous to arrange the illuminators in the horizontal direction when assembling a normal screen that is longer in the horizontal direction. Since the illuminator can be the arrangement length, the display can be manufactured in lower cost.

In order to enhance the intensity of the illuminators 41, 41B-41E, 42 and 43, the outer surface of the glass tube 410 can be coated with an acrylic resin, a silicone resin or other transparent material. In addition, the glass tube 410 can be replaced with a tube made of a resin (e.g., a silicone resin) that is superior to a glass in the intensity and has a thermostability.

According to the present invention, a display device can be realized that has a group of elongated illuminators that enable the electrode matrix to be formed easily.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A display device having a screen including a substrate and a group of elongated illuminators arranged on the substrate, wherein
an elongated electrode supporter is arranged on at least one side of each illuminator in the width direction, the electrode supporter having plural electrodes aligned along the longitudinal direction of the illuminator,
wiring conductor patterns for supplying electricity to the plural electrodes are formed on the substrate, and
a partial light emission of the illuminator is controlled by the wiring conductor pattern and the plural electrodes.

2. The display device according to claim 1, wherein plural conductors for defining the area of the partial light emission are fixed to the outer surface of the illuminator, so that each of the conductors contacts each of the plural electrodes.

3. The display device according to claim 1, wherein the plural electrodes of the electrode supporter are supported by an elastic insulator.

4. The display device according to claim 1, wherein the plural electrodes of the electrode supporter are supported by an insulator so as to be forcing means that press the illuminator.

5. The display device according to claim 1, wherein the electrode supporter has a plate-like shape, the plural electrodes are formed on one side of the electrode supporter, the electrodes are formed on the other side, and the electrode supporter disposed between the neighboring illuminators is used for controlling the illuminators.

6. An integrated display device comprising plural display devices side by side having the same structure as the display device according to claim 1.

7. The display device according to claim 1, wherein the illuminator has a tube-like body containing a discharge gas and a fluorescent material layer that emits light by a gas discharge.

8. The display device according to claim 7, wherein the illuminator has a first fluorescent material layer that is arranged on the rear side of the discharge gas space and a second fluorescent material layer that is arranged on the front side of the discharge gas space and is thinner than the first fluorescent material layer.

9. The display device according to claim 7, wherein the fluorescent material layer of the illuminator is disposed in the tube that encloses the discharge gas space after forming a protection film on the inner surface of the tube.

10. The display device according to claim 7, wherein the fluorescent material layer of the illuminator is formed on a supporting member that is separated from the tube, and the fluorescent material layer is disposed in the tube by inserting the supporting member inside the tube.

11. The display device according to claim 10, wherein a reflection layer is formed on the supporting member.

12. The display device according to claim 7, wherein a conductor is arranged that extends over the entire length in the longitudinal direction inside the discharge gas space of the illuminator.

13. The display device according to claim 1, wherein the substrate has a protrusion for registration of the illuminator, and the illuminator has a recess that engages the protrusion.

14. The display device according to claim 1, wherein the illuminator has a tube-like body containing a discharge gas and a fluorescent material layer that emits light by a gas discharge, plural conductors for defining the area of the partial light emission are fixed to the outer surface of the illuminator so that each of the conductors contacts each of the plural electrodes, the plural conductors are arranged on one side in the front and rear direction, and the fluorescent material layer is arranged on the opposite side to the conductor.
